(19) United States
(12) Patent Application Publication
(10) Pub. No.: US 2011/0057472 A1
(43) Pub. Date: Mar. 10, 2011

(54) SHADING SYSTEM

(75) Inventor: Carsten GLASER, Muhltal (DE)

(73) Assignee: GM GLOBAL TECHNOLOGY OPERATIONS, INC., Detroit, MI (US)

(21) Appl. No.: 12/830,197

(22) Filed: Jul. 2, 2010

(30) Foreign Application Priority Data
Jul. 3, 2009 (DE) 102009031619.1

(51) Int. Cl. B60J 7/04

(52) U.S. Cl. 296/136.11

(57) ABSTRACT

A shading system for a motor vehicle includes, but is not limited to two guide rails disposed laterally spaced apart from one another along a central axis for receiving at least one shading element. The guide rails are at least partially unequally spaced apart from one another, and the shading element is disposed between the guide rails, and the shading element includes, but is not limited to at least one contour plate and at least two compensating plates. The compensating plates are disposed in a non-usage position in a recess inside the contour plate, and the compensating plates may be pivoted out from the recess about an axis of rotation at least partially for transfer from the non-usage position into a usage position.

### CROSS-REFERENCE TO RELATED APPLICATION

This application claims priority to German Patent Application No. 102009031619.1, filed Jul. 3, 2009, which is incorporated herein by reference in its entirety.

### TECHNICAL FIELD

The invention relates to a shading system for a motor vehicle.

### BACKGROUND

Shading systems for motor vehicles are preferably used to cover vehicle roofs, in particular panorama windows, in order to protect the interior of the motor vehicle and the vehicle occupants from light and/or solar irradiation.

Such a shading system is known from EP 1 238 840 A1, which has a sunshade, is disposed under the vehicle roof wound on a winding shaft, may be withdrawn by means of a draw bar guided on guides, and may be positioned in various withdrawal positions.

However, the shading system described in EP 1 238 840 A1 is only suitable for vehicle roofs, whose lateral boundary is substantially parallel, i.e., for shading systems, which have a substantially rectangular geometry. In the case of a wedge-shaped geometry, for example, when covered with the shading system described there, gaps would form between guide rails and shading apparatus, which may disturb the vehicle occupants.

Known from DE 203 08 651 U1 is a shading system for a motor vehicle having two guide rails, a front bar, and a rear bar, which extend between the two guide rails and are guided in said guide rails. In this case, the guide rails are at least in part unequally spaced apart from one another. Provided between the two guide rails is a flexible sunshade, which is fastened to the front and to the rear bar and is guided in the guide rails. The sunshade is here configured as elastic material, which compensates for different widths in the transverse direction through stretching of the elastic material.

A disadvantage in this case is that this sunshade must be pre-stressed in order not to sag and thereby produce a visually negative impression. Another factor is that in the case of larger different widths or distances between the guide rails, other stresses occur in addition to the pre-stressing, which on the one hand only do not lead to damage to or tearing of the sunshade for limited distances and on the other hand, bring about a high wear even for shorter distances so that the lifetime of such a sunshade is very short. In addition, this type of sunshade has a very low inherent stability.

It is therefore at least one object of the present invention to provide a shading system for a motor vehicle, which is distinguished by a very simple structure and which has a high inherent stability so that in the case of roof windows having unequally spaced-apart guide rails, a substantially complete covering of the roof window may be ensured. In addition, other objects, desirable features, and characteristics will become apparent from the subsequent summary and detailed description, and the appended claims, taken in conjunction with the accompanying drawings and this background.

### SUMMARY

The shading system for a motor vehicle according to an embodiment of the invention has two guide rails disposed laterally spaced apart from one another along a central axis for receiving at least one shading element, wherein the guide rails are at least partially unequally spaced apart from one another, and wherein the shading element is disposed between the guide rails, and the shading element comprises at least one contour plate and at least two compensating plates. The compensating plates can be disposed in a non-usage position in a recess inside the contour plate, and the compensating plates may be pivoted out from the recess about an axis of rotation at least partially for transfer from the non-usage position into a usage position.

The compensating plates are provided both on the right and on the left of the contour plate so that by means of the contour plate and the compensating plates disposed laterally thereto, a covering extending over the complete width of the vehicle roof may be achieved. Inside the contour plate a recess may be provided for each compensating plate or however, a plurality of compensating plates may be provided in one recess. For example, the recess may extend over the entire width of the contour plate so that the compensating plates provided to the right and left of the contour plate may be disposed inside this one recess. In this case, the contour plate is preferably provided at the front end of the shading element when seen in the direction of tension. In addition to the contour plate and the compensating plates, the shading element preferably has a cover element, which is provided behind the contour plate when seen in the direction of tension and is merely guided in the region of the guide rails, in which the guide rails run parallel to one another so that no width compensation need be carried out in the region of the cover element.

In the non-usage position, i.e., in the position where the compensating plates are not required to protect against solar irradiation, the compensating plates are preferably disposed completely within the recess of the contour plate. If the shading element is pulled in the direction of tension in the direction of the A-pillar of the vehicle, the compensating plates are transferred from the non-usage position into a usage position as soon as the shading element enters into the region on which the guide rails no longer run parallel to one another but are unequally spaced apart from one another in order to compensate for and therefore be able to cover the gap between contour plate, which is substantially rectangular in shape, and the guide rails. For this purpose the compensating plates are rotatably mounted on the contour plate, so that the compensating plates can be pivoted out, at least in part, about an axis of rotation from the recess inside the contour plate. As a result of the implementation of the width compensation by means of a pivoting of the compensating plates about an axis of rotation, the shading element may be adapted very flexibly to guide rails differently spaced apart from one another, in particular along a large region as is the case, for example, with a panorama window. In order to achieve the most efficient covering, the axis of rotation of the compensating plates is preferably located at the rear end of the contour plate seen in the direction of tension, i.e., on the region of the contour plate where the contour plate adjoins the cover element. The contour plate is thereby guided via the compensating plates into the guide rails. The compensating plates are preferably made of a bending-resistant and dimensionally rigid material so that they have a high inherent stability and may transfer the forces between the contour plate and the guide rails. In the shading system according to the invention, the width compensation is thereby possible without using bars so that the shading system is distinguished by a particularly simple structure and a simple constructive embodiment compared with the known shading systems.

According to an advantageous embodiment of the invention, in each case at least one sliding block cooperating with a guide rail is disposed on the compensating plates. By means of the sliding block the compensating plate can be hooked in the guide rail and guided therein.

It is further provided according to an advantageous embodiment of the invention that bearing elements are provided inside the recess of the contour plate, by which means the compensating plates are mounted movably in the recess. A movement of the compensating elements under load is made possible by the bearing elements. For this purpose the compensating elements preferably lie inside the recess directly on the bearing elements.

According to a preferred embodiment of the invention, the bearing elements are configured in the form of webs disposed parallel to one another. In this case, the webs are preferably arranged in rib form inside the recess. The webs are preferably aligned in the direction of rotation of the compensating plates so that the webs are preferably configured at an angle of approximately <90° to the longitudinal direction of the vehicle.

In order to be able to achieve the most uniform possible movement of the compensating plates, according to a further preferred embodiment of the invention the bearing elements are provided below and above the compensating plate on the inner surface of the recess.

In order to be able to reduce the construction expenditure of the shading system, according to a further advantageous embodiment of the invention, the contour plate is formed from an upper shell and a lower shell, wherein the recess is formed from a first cutout formed in the upper shell and a second cutout formed in the lower shell opposite the first recess. Since the contour plate is formed from two parts, respectively one cutout can be incorporated into both parts by means of milling. If the upper shell and lower shell thus formed are combined in a further manufacturing step, the recess is obtained from the two opposing cutouts. Before the upper shell and the lower shell are combined, the compensating plates may be disposed in the cutouts so that after combining the upper shell and the lower shell, the compensating plates are already disposed in the recess. An expensive incorporation of a recess into a contour plate formed in one piece is therefore eliminated.

In order to be able to protect the driver and the passenger from laterally incident solar irradiation, according to a further preferred embodiment of the invention, the contour plate has one or more indentations for receiving one or more sunshields.

The invention further relates to a motor vehicle comprising a shading system configured and further developed as hereinbefore.

### BRIEF DESCRIPTION OF THE DRAWINGS

The present invention will hereinafter be described in conjunction with the following drawing figures, wherein like numerals denote like elements, and.

FIG. 1 shows a schematic diagram of a shading system according to an embodiment of the invention;

FIG. 2 shows a schematic diagram of the shading system in which the shading element is disposed in a non-usage position;

FIG. 3 shows a schematic diagram of the shading system in which the shading element is disposed in a usage position;

FIG. 4 shows a schematic diagram of the shading system in a lateral sectional view; and

FIG. 5 shows a schematic diagram of the shading system shown in FIG. 4 in which a sunshade is folded out.

### DETAILED DESCRIPTION

The following detailed description is merely exemplary in nature and is not intended to limit application and uses. Furthermore, there is no intention to be bound by any theory presented in the preceding background or summary or the following detailed description.

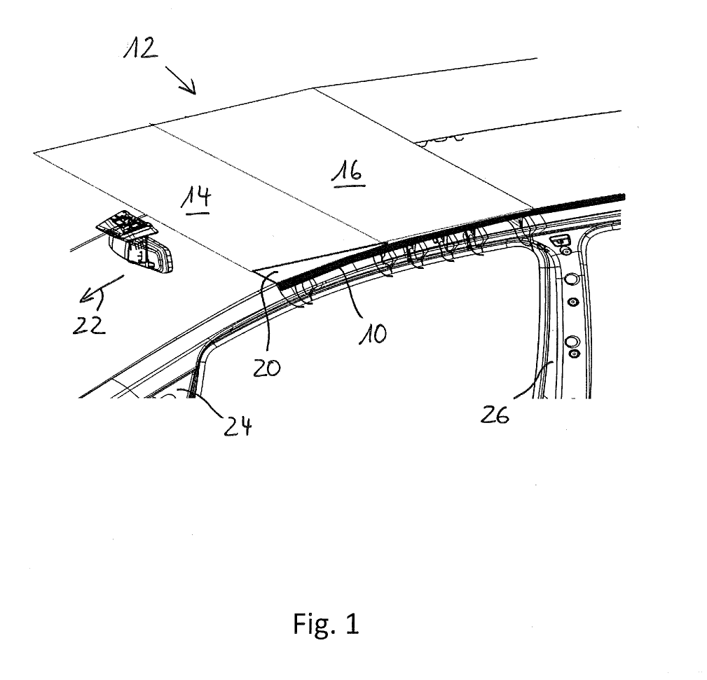

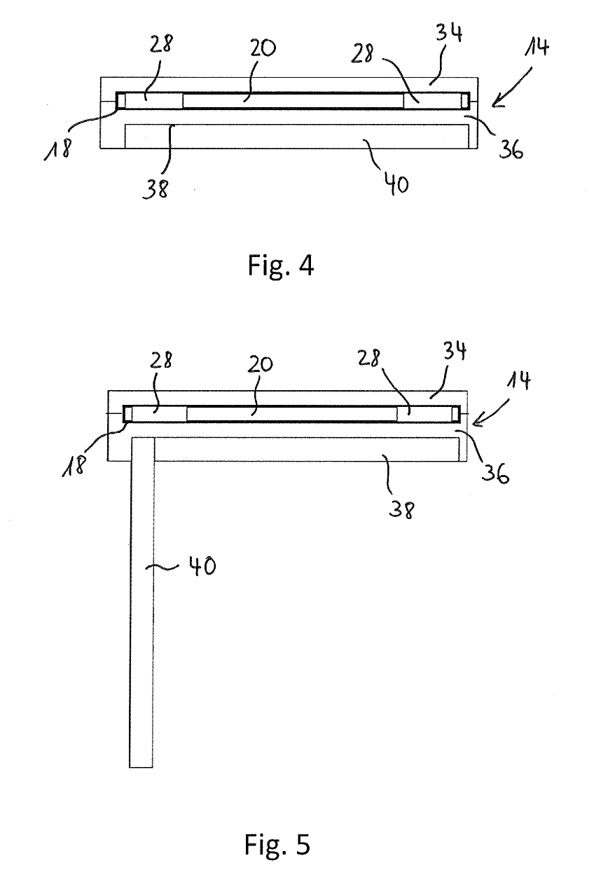

FIG. 1 shows a shading system for a motor vehicle according to the invention, which comprises two guide rails 10 disposed laterally spaced apart from one another along a central axis for receiving a shading element 12. In each case only one of the two guide rails 10 is shown in FIG. 1 to FIG. 3. The shading element 12 is preferably disposed between an A-pillar 24 and a B-pillar 26 inside the vehicle in the region of a vehicle roof and comprises a contour plate 14, a cover element 16, and two compensating plates 20 disposed laterally of the contour plate 14 in a recess 18 (see FIG. 4). In this case, FIG. 1 shows a compensating plate 20 only on one side of the contour plate 14. However it is also provided to provide a compensating plate 20 on the opposite side of the contour plate 14. The cover element 16, which is preferably made of a textile material, a plastic material, and/or a fiber-reinforced plastic material, is disposed behind the contour plate 14 seen in the direction of tension 22. The cover element 16 and the contour plate 14 are preferably both configured to be rectangular. The cover element 16 is guided in the region of the guide rails 10, in which the guide rails 10 run parallel to one another, so that preferably no compensating plates are required in the region of the cover element 16.

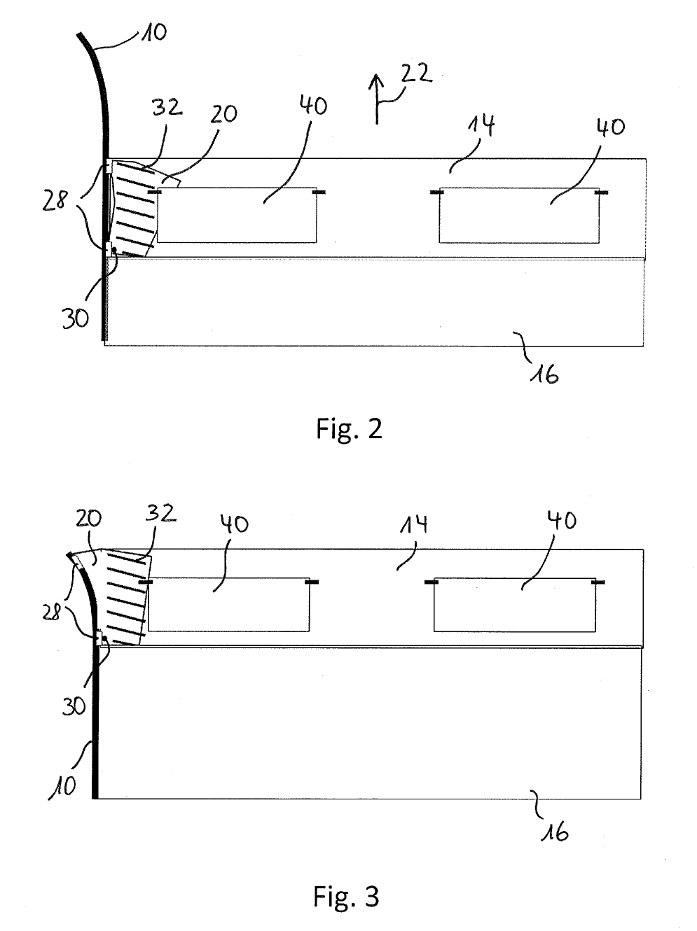

FIG. 2 shows the shading element 12 in a non-usage position, in which the compensating plates 20 are disposed completely within the contour plate 14 so that the compensating plates 20 in the non-usage position may transfer the forces acting accordingly on the shading element 12 to the guide rails 10. The compensating plates 20 each have two sliding blocks 28 by which means the compensating plates 20 are hooked and guided in the guide rails 10. The compensating plates 20 are rotatably mounted on the contour plate 14, so that the compensating plates 20 may be pivoted out about the axis of rotation 30 from the recess 18 inside the contour plate 14 at least in part, as shown in FIG. 3. As a result of the width compensation being implemented by means of a pivoting of the compensating plates 20 about the axis of rotation 30, the shading element 12 may be adapted very flexibly to guide rails 10 which are differently spaced apart from one another, in particular also along a large region as is the case, for example, with a panorama window. In order to achieve the most efficient possible covering, the axis of rotation 30 of the compensating plates 20 is preferably located at the rear end of the contour plate 14 seen in the direction of tension 22, i.e. on the region of the contour plate 14, where the contour plate 14 adjoins the cover element 16.

The compensating plates 20 are movably mounted in the recess 18 by means of bearing elements 32 provided in the recess 19 of the contour plate 14. A movement of the compensating plates 20 under load is made possible by the bearing elements 32. For this purpose, the compensating plates 20 are preferably located inside the recess 18 directly on the bearing elements 32. As shown in FIG. 2 and FIG. 3, the bearing elements 32 are configured in the form of webs disposed parallel to one another. The webs are preferably disposed in rib form inside the recess 18. The webs are preferably aligned in the direction of rotation of the compensating plates 20 so that the webs are preferably configured at an angle of approximately <90° to the longitudinal direction of the vehicle. In order to be able to achieve the most uniform possible rotational movement of the compensating plates 20, the bearing elements 32 are provided below and above the compensating plate 20 on the inner surface of the recess 18.

FIG. 3 shows the shading element 12 in a usage position, in which the shading element 12 preferably covers the entire vehicle roof. When transferring the shading element 12 from the non-usage position into the usage position, the compensating plates 20 are pivoted out from the recess 18 of the contour plate 14 about the axis of rotation 30 in the direction of the guide rails 10. In the usage position the compensating plate 20 is preferably not completely pivoted out from the recess 18 of the contour plate 14, but a partial region of the compensating plate 20 remains in the recess 18, so that despite the pivoted-out state of the compensating plate 20, a transmission of force between the contour plate 14 and the guide rails 10 is still possible.

FIG. 4 and FIG. 5 show a lateral sectional view of the shading element 12 according to the invention shown in FIG. 2 and FIG. 3. In order to be able to reduce the construction expenditure of the shading system, the contour plate 14 is formed from an upper shell 34 and a lower shell 36, wherein the recess 18 is formed from a first cutout formed in the upper shell 34 and a second cutout formed in the lower shell 36 opposite the first recess. Since the contour plate 14 is formed from two parts, the upper shell 34 and the lower shell 36, respectively one cutout can be incorporated into both parts 34, 36 by means of milling. If the upper shell 34 and lower shell 36 thus formed are combined in a further manufacturing step, the recess 18 is obtained from the two opposing cutouts. Before the upper shell 34 and the lower shell 36 are combined, the compensating plates 20 may be disposed in the cutouts so that after combining the upper shell 34 and the lower shell 36, the compensating plates 20 are already disposed in the recess 18.

In order to be able to protect the driver and the passenger from laterally incident solar irradiation, the contour plate 14 has one or more indentations 38 for receiving one or more sunshields 40. The sunshields 40 are preferably disposed underneath the compensating plates 20 in the contour plate 14.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A shading system for a motor vehicle, comprising:
a shading element comprising at least one contour plate and at least two compensating plates;
at least two guide rails disposed laterally spaced apart from one another along a central axis for receiving the shading element that is disposed between the at least two guide rails, the at least two guide rails at least partially unequally spaced apart from one another,
wherein the at least two compensating plates are adapted to be disposed in a non-usage position in a recess inside the at least one contour plate, and
wherein the at least two compensating plates are adapted to pivot out from the recess about an axis of rotation at least partially for transfer from the non-usage position into a usage position.

2. The shading system according to claim 1, further comprising at least one sliding block, which is adapted to cooperate with at least one of the at least two guide rails, is disposed on the at least two compensating plates.

3. The shading system according to claim 1, further comprising bearing elements inside the recess by which the at least two compensating plates are movably mounted in the recess.

4. The shading system according to claim 3, wherein the bearing elements are configured in a form of webs disposed parallel to one another.

5. The shading system according to claim 3, wherein the bearing elements are provided below and above the at least two compensating plates on an inner surface of the recess.

6. The shading system according to claim 1, wherein the at least one contour plate is formed from an upper shell and a lower shell and the recess is formed from a first cutout formed in the upper shell and a second cutout formed in the lower shell opposite the first cutout.

7. The shading system according to claim 1, wherein the at least one contour plate (14) comprises at least one indentation adapted to receive at least one sunshield.
